(19) United States
(12) Patent Application Publication
(10) Pub. No.: US 2024/0333130 A1
(43) Pub. Date: Oct. 3, 2024

(54) DC DISTRIBUTION SYSTEM, AND A POWER CONVERTOR FOR USE IN SUCH DC DISTRIBUTION SYSTEM

(71) Applicant: ABB Schweiz AG, Baden (CH)

(72) Inventor: Fabio Tombelli, Wateringen (NL)

(21) Appl. No.: 18/556,851

(22) PCT Filed: Aug. 27, 2021
(86) PCT No.: PCT/EP2021/073800

§ 371 Date: Oct. 23, 2023

Related U.S. Application Data
(60) Provisional application No. 63/178,980, filed on Apr. 23, 2021.

(51) Int. Cl. H02M 1/00; H02J 1/12; H02M 5/12

(52) U.S. Cl. CPC H02M 1/007; H02J 1/12; H02M 5/12; H02J 2300/22; H02J 2300/28

(57) ABSTRACT

A Direct Current (DC) distribution system is provided. The Direct Current (DC) distribution system including a Direct Current bus configured for operating at direct current (DC), a power source input electrically connected to the DC bus and configured for receiving an Alternating Current (AC) voltage from an AC source, and an electrical load electrically connected to the DC bus and configured for operating at DC and/or an additional power source electrically connected to the DC bus, wherein a first power converter electrically connected to the DC bus and the power source input and configured for converting AC received at the power source input to DC for the DC bus, and a second power converter is electrically connected to the DC bus and the electrical load and/or to the DC bus and the additional power source.

### CROSS REFERENCE TO RELATED APPLICATIONS

This patent application is a National Stage Entry of PCT/EP2021/073800 filed on Aug. 27, 2021, which claims the benefit and priority of U.S. Provisional Patent Application No. 63/178,980 filed on Apr. 23, 2021, the disclosures of which are incorporated by reference herein in their entirety as part of the present application.

### BACKGROUND

The disclosure relates to a Direct Current (DC) distribution system, in particular a managed, grid integrated and/or self-contained DC distribution system, connected or connectable to an electrical power source.

Furthermore, the disclosure relates to a power convertor for use in a DC distribution system.

Such a distribution system is known from the prior art. The known distribution system includes a DC bus having a power source input electrically connected to the DC bus and configured for receiving an Alternating Current (AC) from an AC source, such as an AC grid. The distribution system is provided with an AC/DC converter for converting the AC from the AC grid to a DC to be provided to the DC bus. A number of electrical loads, such as an electric vehicle charger and/or building loads, are connected to the DC bus, which electrical loads are provided with electrical power by the DC bus. A DC/DC converter is provided between each of the electrical loads and the DC bus in order to convert the DC of the DC bus to a DC that is useable by the respective electrical load.

### BRIEF DESCRIPTION

A disadvantage of the known DC distribution system is that it is fed by conventional AC/DC converters connected to a low voltage, LV, grid or a medium voltage, MV, grid via a MV substation. Conventional converters usually are connected to 50 or 60 Hz low voltage (LV) or medium voltage (MV) grids. For applications where a MV grid is needed a MV substation is likely to be used between the grid and the AC-DC converter. The MV substation is commonly composed by a MV stall, a MV/LV transformer, and LV breakers. The transformer operating at 50/60 Hz has a disadvantage as the size, since it applies that the lower the operating frequency, the larger the transformer has to be. Since the transformer has to be large, much material is needed.

It is an aspect of the present disclosure to ameliorate or to eliminate one or more disadvantages of the known prior art, to provide an improved DC distribution system or to at least provide an alternative DC distribution system.

According to a first aspect, the disclosure provides a Direct Current (DC) distribution system, including:
a Direct Current bus configured for operating at direct current (DC),
a power source input electrically connected to the DC bus and configured for receiving an Alternating Current (AC) voltage from an AC source, and
an electrical load electrically connected to the DC bus and configured for operating at DC and/or an additional power source electrically connected to the DC bus,
wherein a first power converter is electrically connected to the DC bus and the power source input, which first power converter is configured for converting AC received at the power source input to DC for the DC bus, and a second power converter is electrically connected to the DC bus and the electrical load and/or to the DC bus and the additional power source, which second power converter is configured for converting DC from the DC bus to DC and/or for converting DC or AC from the additional power source to DC, wherein the first power converter and/or the second power converter include a converter based on solid state transformer (SST) technology, and
wherein the power of the first power converter is lower than the electric load connected to the DC bus, thereby introducing a load factor smaller than 1.

During operation of the DC distribution system according to the disclosure, at least one of the first power convertor and the second power convertor includes solid state transformer (SST) technology that contributes to converting an AC from an AC source to a DC voltage to be provided to the DC bus and/or to be provided to the electrical load electrically connected to the DC bus. Solid state transformer technology, at least in the context of the present disclosure, is working at a high operating frequency in comparison to the operating frequency of a conventional transformer, such as an AC/DC converter. The high operating frequency allows the power converter to be designed with a smaller core in comparison with the known power converter. Therefore, less wire and less magnetic material are required for the power converter based on SST technology in comparison to the known conventional converter. Therefore, the power converter based on the SST technology is smaller than the MV/LV transformer and the AC/DC converter as known in the prior art. Furthermore, due applying a load factor that is below 1 to the DC distribution system, the dimensions of the first power converter may be kept relatively small in comparison to the MV/LV transformer and the AC/DC converter as known in the prior art.

In an embodiment, the first power converter includes the converter based on SST technology. In an embodiment thereof, the first power converter includes, in series:
a first AC/DC converter configured for rectifying the AC voltage to a DC voltage and providing the DC voltage to a DC/AC converter;
the DC/AC converter configured for converting the DC voltage to a converted AC voltage, which may be lower than the AC voltage from the AC source, and for providing the converted AC voltage to the SST technology;
the SST technology configured for dropping the AC voltage to a predetermined value and for providing the dropped AC voltage to a second AC/DC converter; and
the second AC/DC converter configured for providing a regulated DC voltage to the DC bus. The first power converter may be configured for providing a low voltage (LV) DC to the DC/AC converter, and/or the DC bus is operating at a low voltage DC. During use, the first AC/DC converter receives an AC, may be with a first frequency, for example 50 or 60 Hz, from the AC source, such as an AC grid or a power generator, and rectifies the received AC into a medium voltage (MV) DC voltage that is provided to the DC/AC converter. The DC/AC converter converts the MV DC voltage into an AC with a lower voltage than the voltage of the AC source, and may be with a second frequency that is higher than the first frequency, and provides it to the SST technology. The SST technology, which may be embodied as a high-frequency SST, drops the voltage to a predetermined voltage that, for example, is appropriate for a low voltage (LV) DC bus. The second AC/DC converter, which is connected to the SST technology, receives the dropped voltage, and provides a regulated DC voltage at a predetermined potential. An advantage of this embodiment is that a LV DC voltage is provided to the DC bus at a predetermined potential in an efficient manner.

In the context of the present disclosure, low voltage (LV) may be understood as a voltage up to 1000 Vac and 1500 Vdc, and medium voltage may be understood as a voltage from 1000 Vac/1500 Vdc to 36 kVac/50 kVdc.

In an embodiment, the second power converter includes the converter based on SST technology. In an embodiment thereof, the second power converter includes, in series:
a DC/AC converter configured for converting the DC voltage from the DC bus to a converted AC voltage, which may be lower than the AC voltage from the AC source, and for providing the converted AC voltage to the SST technology;
the SST technology configured for dropping the AC voltage to a predetermined value and for providing the dropped AC voltage to a second AC/DC converter; and
the second AC/DC converter configured for providing a regulated DC voltage to the electrical load. In an even further embodiment, the second power converter is configured for providing a low voltage (LV) DC to the electrical load. The first power converter may include a first AC/DC converter configured for rectifying the AC voltage to a medium voltage (MV) DC voltage or a low voltage (LV) voltage, and/or the DC bus is operating at a MV or LV DC. According to the embodiment, the DC/AC converter converts the MV DC voltage from the DC bus into an AC, for example, with a lower voltage than the voltage of the AC source and provides it to the SST technology. The SST technology, which may be embodied as a high-frequency SST too, drops the voltage to a predetermined voltage that, for example, is appropriate for a low voltage (LV) DC application. The second AC/DC converter, which is connected to the SST, receives the dropped voltage, and provides a regulated DC voltage at a predetermined potential. As a result, the DC bus is operating at MV and the MV DC is converted into a LV DC just before the point where the LV DC is required. Thus, the MV DC may be transported from the first power converter to the second power converter via the DC bus, which may be provided with electricity cables for transporting the MV DC. As electricity cables for MV are cheaper than electricity cables for LV, an advantage of this embodiment is that LV may be provided to one or more electrical loads in a relatively cheap manner.

In an embodiment, the DC distribution system includes a controller communicatively connected to each of the first power converter and the second power converter, wherein the controller is configured for controlling each of the first power converter and the second power converter. During operation, the controller may collect and monitor operation of the first and second power converters, for example, in order to determine how much power is converted by each of the first and second power converters. As a result, the controller advantageously may be enabled to determine, for example, whether the electrical load is operating optimally, and/or to adjust power provided to or from the electrical load/the DC bus by adjusting operating parameters of the first and/or second power converter. This allows the DC distribution system according to this embodiment to achieve optimal operation.

In an embodiment, the DC distribution system includes a virtual power plant (VVP) connected to the controller and to an open power market, such as a frequency containment reserve (FCR) market, and configured for providing use information to the controller. The DC distribution system may include multiple electrical loads, such as one or more electric vehicle (EV) chargers and one or more batteries, connected to the DC bus. The VVP is connected to the open power market and, therefore, is enabled to determine, for example, whether the power prices on the AC grid are high or low and to provide this information to the controller. In the case of high power prices, the controller may determine to draw excess power from the DC bus and offer it for sale to the AC grid, and in the case of low power prices, the controller may determine to store additional power in the one or more batteries. An advantage of this embodiment, therefore, is that power may be bought and/or sold on appropriate moments such that the operating costs of the DC distribution system are controllable.

In an embodiment, the DC distribution system includes a fleet management controller connected to the controller and configured for managing charging of a fleet of electric vehicles. During use, the fleet management controller, for example, may determine which electric vehicles in a fleet have to be charged and communicate this information to the controller. Subsequently, the controller, for example, may control the first power converter to convert some additional power to provide additional power into the DC distribution system in advance, and/or the controller may decide to not sell any power as the power is required within the DC distribution system on a short notice. This is advantageous, as the fleet management controller allows the DC distribution system to be prepared for a power demand in the near future.

In an embodiment, the electric load is selected from a group including an electric vehicle charger, an electric trolley system, building loads, and the like.

In an embodiment, the power source input is connected to an AC grid, to an AC power generator and/or to a mechanical power source, and/or one or more additional power sources are electrically connected to the DC bus, wherein the one or more additional power sources are selected from a group including solar panels, wind turbines, energy storages, and the like.

According to a second aspect, the disclosure provides a power convertor for use in a DC distribution system according to the first aspect of the disclosure, wherein the power convertor includes, in series:
a first AC/DC converter configured for rectifying an AC voltage to a DC voltage and providing the DC voltage to a DC/AC converter;
the DC/AC converter configured for converting the DC voltage to a converted AC voltage, which may be lower than the AC voltage from the AC source, and for providing the converted AC voltage to a SST technology;
the SST technology configured for dropping the AC voltage to a predetermined value and for providing the dropped AC voltage to a second AC/DC converter; and
the second AC/DC converter configured for outputting a regulated DC voltage.

The power convertor according to the disclosure has at least the same technical advantages as described in relation to the DC distribution system according to the first aspect of the disclosure.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The disclosure will be elucidated on the basis of an exemplary embodiment shown in the attached drawings, in which:

FIG. 1 shows a schematic view of a first embodiment of an alternating current (AC) to DC converter (AC/DC) in accordance with the disclosure;

FIG. 2 shows a schematic view of a second embodiment of an AC/DC converter in accordance with the disclosure:

FIG. 3 shows a block diagram of a DC distribution system that includes a DC bus disposed at a LV DC potential in accordance with the disclosure:

FIG. 4 shows a block diagram of a DC distribution system that includes a DC bus disposed at a MV DC potential in accordance with the disclosure; and

FIG. 5 shows a block diagram of a DC, self-contained distribution system in accordance with the disclosure.

### DETAILED DESCRIPTION

The present disclosure is applicable to managed, grid integrated and/or self-contained DC distribution systems, which include both electrical power sources and sinks.

In one embodiment, the DC distribution system includes a (AC/DC or DC/DC) feeding or fed by DC or AC load/sources such as solar, storage, wind and the like. In this embodiment, DC distribution is connected to a MV AC grid via one or more converters based on solid state transformer technology (SST). DC distribution can be in medium voltage (MV) or low voltage (LV) in accordance with prevailing standards. For such use case, LV is most likely but depends on the intended application. Multiple SST connected in parallel on the same DC distribution can be used. The power of SST is lower than the power needed in the system. In accordance with a load factor principle, all the converters are connected to the site controller. The site controller manages power/energy flow keeping the entire DC distribution system operating within prescribed limits and in stable operative conditions. The site controller is connected to a back-end platform (VPP) acting as aggregator manager for one or more site controllers simultaneously. Based on operative conditions, the VPP sets a predefined or desired set point or limitations to the converters. The VPP, based on the current operating conditions and/or local requirements is configured and operates to sell or purchase electrical energy from or to a market, for example, the Frequency Containment Reserve (FCR) Market. The site controller is also connected to a fleet management instrumentality. Most of the converters are isolated, which helps to confine any failures. Each converter might be equipped with a switch and protection device such as a fuse or solid state breaker. In accordance with this first embodiment, SST multiple DC distributions are generated with different voltage levels for different consumers/sinks such as electric vehicles, building loads, and the like.

In a second embodiment, similar to the first embodiment, a DC distribution system is shown. Here, due to higher power than in the first embodiment, the DC distribution system includes a DC bus that is disposed at a medium voltage (MV) and the DC power distributed is generated by one or more AC/DC converters connected to a MV AC grid. MV DC/LV DC isolated converters (Part of SST technology) are connected to the MV distribution stepping down the voltage for low voltage applications. Additional converters are connected to the above converters on LV DC side or to supply local loads. The DC distribution system may include storage devices such as batteries, as well as power generation devices such as solar and wind generation systems. Power converters associated with the bus are configured and operate to also provide load regulation. If the load does not require or have wide power variations, the additional converters may be omitted and may be used. In the event a trolley (catenary) is present, the MVDC/LVDC converter can be used to feed directly the line, such that a converter in between may not be needed. Storage may also be included for peak shaving.

In a third embodiment, which uses the same general structure as the first and/or second embodiments for DC distribution systems, the DC bus may operate at a MV, for example, in the case of a mining truck or marine application. Compared to the first and second embodiments, in the third embodiment, MV DC distribution is generated by one or more AC/DC converters connected to a synchronous generator that is driven or powered by a prime mover, for example, an internal combustion or other type of engine, for example, a gas turbine. If the vessel or truck is full electric, only a storage battery is present. In the case of an electric truck, an energy dissipater can also be used to burn excess energy.

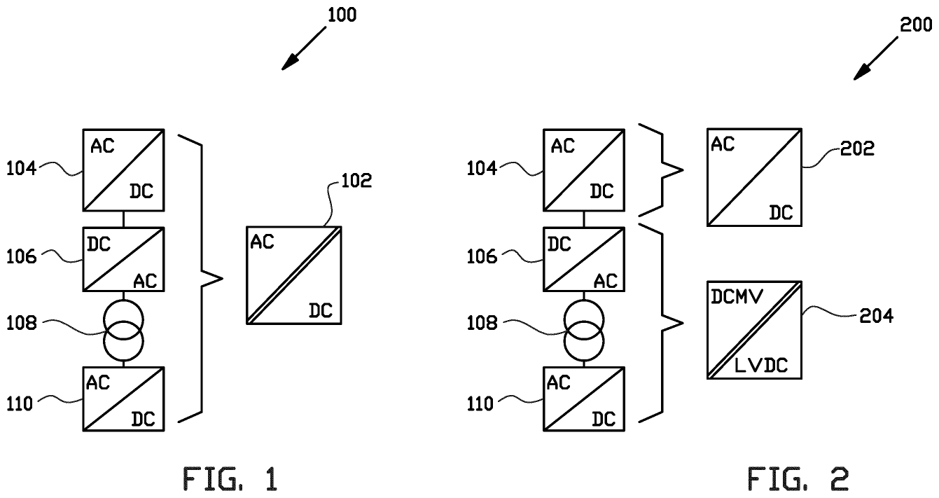

More specifically, two types of power converters will first be described, followed by a description of the three DC distribution system embodiments. In reference to the figures, FIG. 1 represents a first type of power converter 100. The power converter 100 is an AC/DC converter 102 that provides LV DC current from an AC source. As shown in the broken out view on the left side of the figure, a first AC/DC converter 104 is connected to an MV or high voltage (HV) AC connection, for example, an AC power grid (not shown). The first converter 104 rectifies the grid voltage to a MV DC voltage, which is provided to a DC/AC converter 106. The DC/AC converter provides AC power at a lower voltage than the voltage of the AC grid to an SST 108, which can be embodied as a high-frequency SST, which drops the voltage to a desired value, for example, that is appropriate for a LV DC bus. A second AC/DC converter 110 connected to the SST 108 provides a regulated, DC voltage at a desired potential for use in an application.

As is known, the SST 108 can be embodied in many forms. In general, a SST is a collection of high-powered semiconductor components, conventional high-frequency transformers, control circuitry and, additionally or alternatively, power electronics that are used to provide an elevated level of flexible control to power distribution networks. By adding some communication capability, the entire package is often referred to as a smart transformer. SST technology can step up or step-down AC voltage levels just like that of the traditional transformer, but it also offers several significant advantages. They use transistors and diodes and other semiconductor-based devices that, unlike the transistors used in computer chips, are engineered to handle high power levels and very fast switching. The SST 108 is of the step-down voltage type.

A second type of power converter 200 is shown in FIG. 2. In this embodiment, the components included in the device are similar to those of the first power converter 100, and are denoted by the same reference numerals as used in FIG. 1 for simplicity. In this embodiment, however, a first AC/MV DC converter 202 is used to indicate the first AC/DC converter, before the DC/AC converter 106, to provide DC voltage at a MV level. A DC/DC transformer 204 is then used to indicate the DC/AC converter 106, the SST 108, and the second AC/DC Converter 110 to provide a stepped down, LV DC potential. Use of the first or second type of converter 100 or 200 depends on system configuration and architecture, as shown in the embodiments described below.

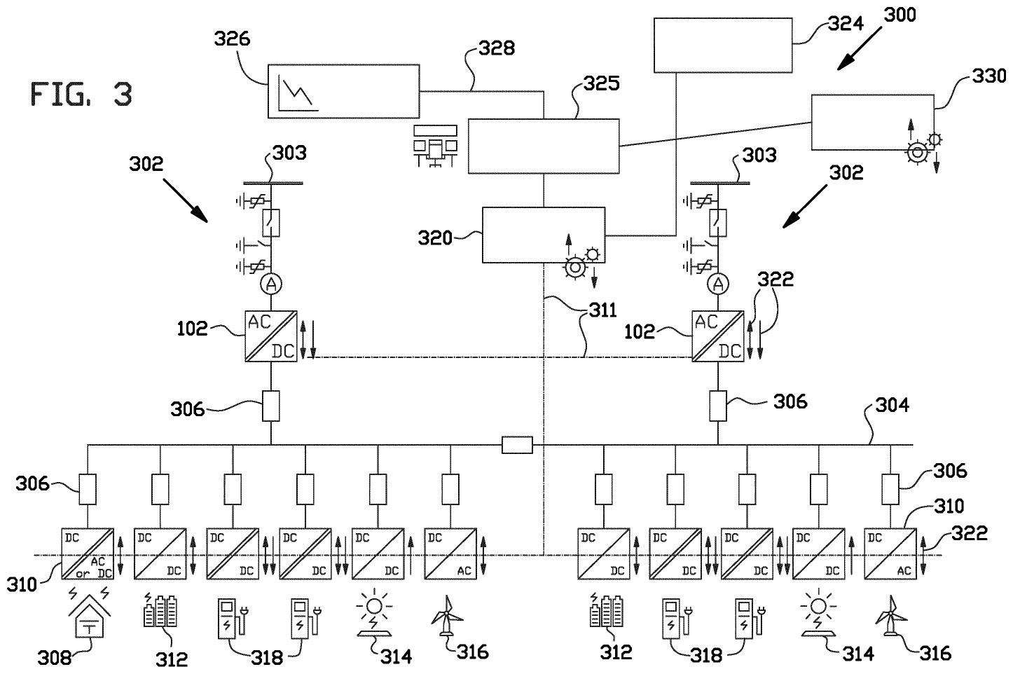

A first embodiment of a distribution system 300 is shown in FIG. 3. In this embodiment, a smart and controllable circuit breaker arrangement 302 and an AC/DC converter 102 (FIG. 1) are used to connect a power grid 303 to a LV DC Bus 304. In the distribution system 300, two such connections to the grid 303 are included to power two major branches of the DC Bus 304. The two branches, and also the connections to the Bus 304 to the AC/DC converters 102, are connected through DC switches 306, which can include DC fuses, solid state breakers, and the like, which operate autonomously or in response to control signals for selective and/or automatic activation or deactivation of the DC Bus 304. The DC Bus 304 is connected to a plurality of sources or sinks of electrical power, also called electric loads. For example, a building 308 may be connected to the bus 304 as a sink, also called electric load, through a DC switch 306 and an appropriate DC/AC or DC/DC converter or transformer, which is generally a power converter 310, which can step up or down and rectify the power provided to operate building systems. Importantly, the power converter 310 may selectively measure and/or control the amount of power and direction of power flow to and from the DC bus 304 from a building 308, or other consumer, in response to command signals provided through a command communication line 311. It is noted that the power of the AC/DC converter 102 is lower than the electric load 308, such that the load factor is lower than 1.

The DC bus 304 can also be connected to battery arrays 312 through a power converter 310, which can be the same or similar to operation and function to the power converter 310 connected to the building 308. Additional sources connected to the bus 304 through power controllers can include solar arrays 314, wind turbines 316 and the like. The bus 304 may also be connected to EV charging stations 318, which may also be connected to the communication line 311. In the embodiment shown, the types of sources and sinks connected to each branch of the bus 304 are distributed in a balanced fashion, but it should be appreciated that other arrangements can be used. Importantly, a site controller 320 operates to balance the power on the bus 304 by monitoring, with the aid of sensors 322, the overall power flow direction on each branch and connected device on the bus, and also the power transferred overall into or out from the bus and also the power into and out from each of the connected devices 308, 312, 314, 316, 318, and the like.

During operation, the site controller 320, which may be implemented in software and/or hardware and includes programming ability to execute computer instructions selectively to control various devices or systems, is connected to the command line 311 and is configured to send and receive information and commands there through. For example, the site controller 320 may collect and monitor operation of all devices to determine whether each device is operating in an optimum fashion and adjust the power provided to/from each device to achieve optimum operation.

Moreover, the site controller 320 may monitor the total power in/out of the DC bus and adjust the operation of sources or sinks connected to the DC bus accordingly. In one example, the site controller 320 may adjust operating parameters of the AC/DC converters 102 to provide more or less power to the bus 304. Also, the site controller 320 can adjust the power input or output to the bus, and/or store or release power from the batteries 312, when more or less consumption is expected to be provided to the EV charging stations 318. In this respect, the site controller 320 may communicate with a fleet management controller 324 to determine which vehicles in a fleet will be needing power, and when, so that the site controller 320 can schedule production or input of power to the bus in advance.

The site controller 320 is also connected to a virtual power plant (VPP) 325, which communicates with the open power market such as the frequency containment reserve (FCR) market 326 via a broker 328, and thus provide information to the site controller 320 or one or more additional site controllers 330 in one or more different facilities that is indicative of the most beneficial use of power. For example, on a windy and sunny day when production is ample and grid demand dictates a high sale price for power, the site controller 320 may draw excess power generation in the bus and provide it for sale to the grid, provided the fleet management controller 324 indicates no excessive need in the near future by vehicles for charging that would exceed the power generation capacity. At times of low prices on the grid, the site controller 320 may instead opt to store power in the batteries 312 provided that the storage conditions are optimum for the life expectancy and operating conditions of the batteries 312.

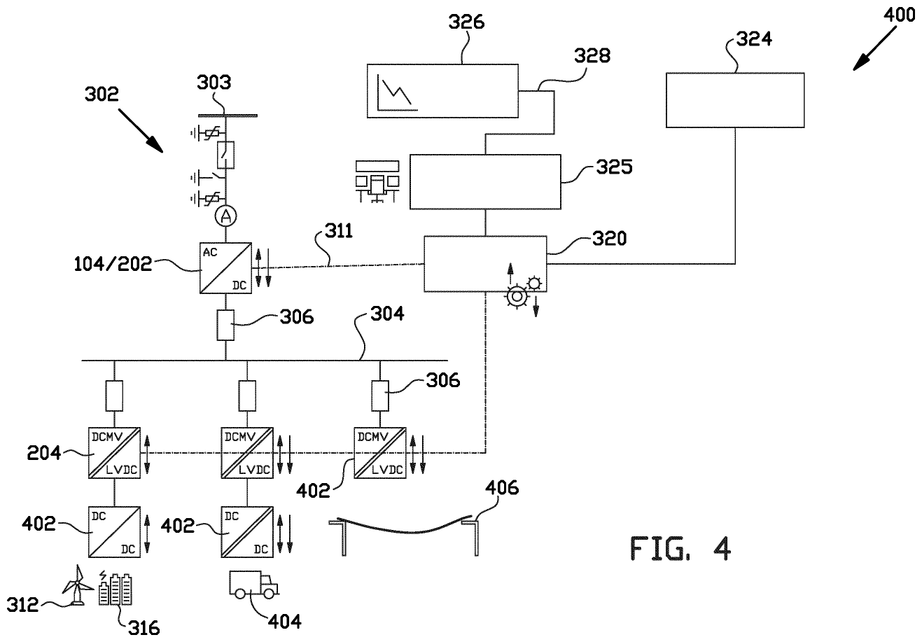

A second embodiment of a distribution system 400 is shown in FIG. 4. In this embodiment, components and system that are the same or at least similar to components and systems previously described are denoted by the same reference numerals previously used for simplicity. As can be seen here, the AC/DC converters are split between a MV conversion stage and a DC/DC step up/down stage in accordance with the second type of power converter 200 arrangement shown in FIG. 2 but multiplied to cover numerous sources/sinks.

More specifically, in reference to FIG. 2, it was described that a first AC/MV DC converter 202 indicates the first AC/DC converter, before the DC/AC converter 106, to provide DC voltage at a MV level. A DC/DC transformer 204 indicates the DC/AC converter 106, the SST 108, and the second AC/DC converter 110 to provide a stepped down, LV DC potential. As can be seen in FIG. 4, the AC/MV DC converter 202 is connected to the grid power to provide MV DC potential to power the bus 304. In this way, current draw is decreased through the higher voltage of the bus to transfer to consumers that may be disposed at longer distances from the converter 202 to minimize losses.

Each source, for example, wind and battery 312 and 316, is connected to the bus via a respective DC/DC transformer 204 (also see FIG. 2) and, depending on the operating requirements an additional step up or step down DC/DC converter 402 can also be used. The same arrangement can be used to power a large vehicle such as a truck 404, which requires charging using commercial vehicle standards at high power levels for fast charging. Advantageously, the case of a trolley, mining truck or other application in which an overhead line or charged third rail track is used, in general a power input 406, to power or supplement the motive power of a machine, the second DC/DC transformer 204 may be omitted so that the power input 406 may be directly supplied.

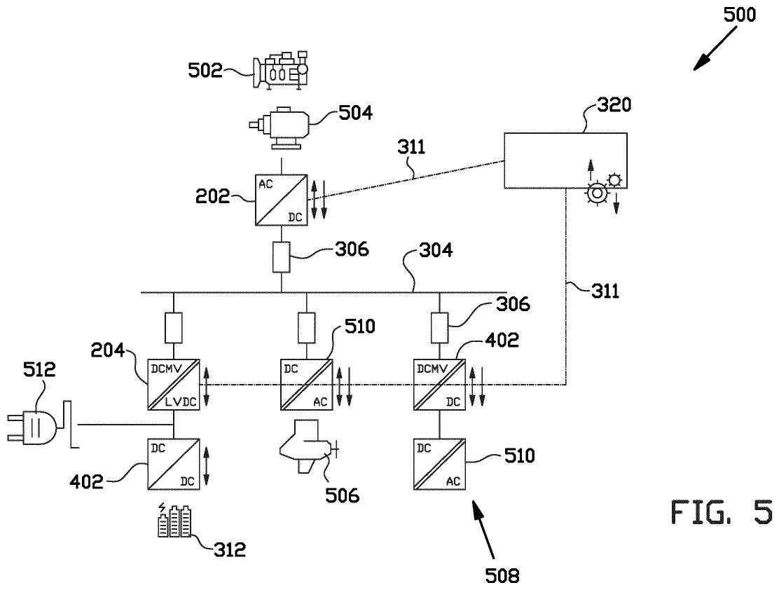

In a third embodiment, a self-contained distribution system 500 is shown in FIG. 5. As with the second embodiment, components and system that are the same or at least similar to components and systems previously described are denoted by the same reference numerals previously used for simplicity. As can be seen here, the standalone system 500 includes a mechanical power source 502 such as a diesel engine that powers an electrical power generator 504. The generator 504 may be an AC power generator that is connected to an input, in place of the power grid as shown in the previous embodiments, of a converter 202, which as previously describes rectifies AC power to a MV DC power, which is provided to the bus 304. The bus includes batteries 312 and also other consumers such as motor drives 506, onboard auxiliary circuits 508, and the like. Depending on the type of sink, the connection to the bus 304 may include a DC/DC transformer 204, with a further step down/step up device 402, a DC/AC converter 510 for driving the motor or aux circuits, and the like. The system may also include a grid power connection 512 for use when grid power is available to save fuel on the diesel engine 502.

In all described embodiments, the site controller 320 is configured to manage all power inputs and consumption on the bus 304, and do so in a way that optimizes use of the devices connected thereto. For example, power may be allocated to a sink, battery, or for sale back to the grid when excess capacity exists, even if such excess capacity could have been used by the sinks but would have caused them to operate in a sub-optimal fashion. The site controller thus sets limits in the electrical power can is delivered through any node connecting the bus to the grid and to each source/sink.

Example embodiments of this disclosure are described herein, including the best mode known to the inventors for carrying out the disclosure. Variations of those example embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

It is to be understood that the above description is included to illustrate the operation of the example embodiments and is not meant to limit the scope of the disclosure. From the above discussion, many variations will be apparent to one skilled in the art that would yet be encompassed by the scope of the present disclosure.

1. A Direct Current (DC) distribution system comprising:
a Direct Current bus configured to operate at the direct current (DC);
a power source input electrically connected to the DC bus and configured for to receive an Alternating Current (AC) voltage from an AC source,
wherein an electrical load is electrically connected to the DC bus and configured to operate at DC and/or an additional power source electrically connected to the DC bus,
wherein a first power converter is electrically connected to the DC bus and the power source input, wherein the first power converter is configured to convert AC received at the power source input to DC for the DC bus, wherein a second power converter is electrically connected to the DC bus and the electrical load and/or to the DC bus and the additional power source, wherein the second power converter is configured to convert DC from the DC bus to DC and/or to convert DC or AC from the additional power source to DC, and wherein the first power converter and/or the second power converter comprise a converter based on solid state transformer (SST) technology, and
wherein the power of the first power converter is lower than the electric load connected to the DC bus, thereby introducing a load factor smaller than 1.

2. The DC distribution system according to claim 1, wherein the first power converter comprises the converter based on SST technology.

3. The DC distribution system according to claim 2, wherein the first power converter comprises, in series:
a first AC/DC converter configured to rectify the AC voltage to a DC voltage and provide the DC voltage to a DC/AC converter;
the DC/AC converter configured to convert the DC voltage to a converted AC voltage, which is lower than the AC voltage from the AC source, and configured to provide the converted AC voltage to the SST technology;
the SST technology configured to drop the AC voltage to a predetermined value and configured to provide the dropped AC voltage to a second AC/DC converter; and
the second AC/DC converter configured to provide a regulated DC voltage to the DC bus.

4. The DC distribution system according to claim 3,
wherein the first AC/DC converter is configured to provide a low voltage (LV) DC to the DC/AC converter.

5. The DC distribution system according to claim 1, wherein the second power converter comprises the converter based on SST technology.

6. The DC distribution system according to claim 5, wherein the second power converter comprises, in series:
a DC/AC converter configured to convert the DC voltage from the DC bus to a converted AC voltage, which is lower than the AC voltage from the AC source, and configured to provide the converted AC voltage to the SST technology;
the SST technology configured to drop the AC voltage to a predetermined value and configured to provide the dropped AC voltage to a second AC/DC converter; and
the second AC/DC converter configured to provide a regulated DC voltage to the electrical load.

7. The DC distribution system according to claim 6, wherein the second power converter is configured to provide a low voltage (LV) DC to the electrical load.

8. The DC distribution system according to claim 5, wherein the first power converter comprises a first AC/DC converter configured to rectify the AC voltage to a medium voltage (MV) DC or a low voltage (LV) voltage.

9. The DC distribution system according to claim 1, comprising a controller communicatively connected to each of the first power converter and the second power converter, wherein the controller is configured to control each of the first power converter and the second power converter.

10. The DC distribution system according to claim 9, comprising a virtual power plant (VVP) connected to the controller and to an open power market, and configured to provide use information to the controller.

11. The DC distribution system according to claim 9, comprising a fleet management controller connected to the controller and configured to manage charging of a fleet of electric vehicles.

12. The DC distribution system according to claim 1, wherein the electric load includes an electric vehicle charger, an electric trolley system, and/or building loads.

13. The DC distribution system according to claim 1, wherein the power source input is connected to an AC grid, to an AC power generator and/or to a mechanical power source, and/or wherein one or more additional power sources are electrically connected to the DC bus, wherein the one or more additional power sources include solar panels, wind turbines, and/or energy storages.

14. A power convertor for use in a DC distribution system according to claim 1, wherein the power convertor comprises, in series:
a first AC/DC converter configured to rectify an AC voltage to a DC voltage and provide the DC voltage to a DC/AC converter;
the DC/AC converter configured to convert the DC voltage to a converted AC voltage, which is lower than the AC voltage from the AC source, and configured to provide the converted AC voltage to a SST technology;
the SST technology configured to drop the AC voltage to a predetermined value and provide the dropped AC voltage to a second AC/DC converter; and
the second AC/DC converter configured to output a regulated DC voltage.

15. The DC distribution system according to claim 2, wherein the first power converter comprises, in series:
a first AC/DC converter configured to rectify the AC voltage to a DC voltage and provide the DC voltage to a DC/AC converter;
the DC/AC converter configured to convert the DC voltage to a converted AC voltage and configured to provide the converted AC voltage to the SST technology;
the SST technology configured to drop the AC voltage to a predetermined value and configured to provide the dropped AC voltage to a second AC/DC converter; and
the second AC/DC converter configured to provide a regulated DC voltage to the DC bus.

16. The DC distribution system according to claim 15, wherein the first AC/DC converter is configured to provide a low voltage (LV) DC to the DC/AC converter.

17. The DC distribution system according to claim 15, wherein the DC bus is operating at a low voltage DC.

18. The DC distribution system according to claim 3, wherein the DC bus is operating at a low voltage DC.

19. The DC distribution system according to claim 5, wherein the second power converter comprises, in series:
a DC/AC converter configured to convert the DC voltage from the DC bus to a converted AC voltage and configured to provide the converted AC voltage to the SST technology;
the SST technology configured to drop the AC voltage to a predetermined value and configured to provide the dropped AC voltage to a second AC/DC converter; and
the second AC/DC converter configured to provide a regulated DC voltage to the electrical load.

20. The DC distribution system according to claim 19, wherein the second power converter is configured to provide a low voltage (LV) DC to the electrical load.

21. The DC distribution system according to claim 5, wherein the DC bus is operating at a MV or LV DC.

22. The DC distribution system according to claim 9, comprising a virtual power plant (VVP) connected to the controller and to an open power market including a frequency containment reserve (FCR) market, and configured to provide use information to the controller.
